(19) United States
(12) Patent Application Publication
(10) Pub. No.: US 2014/0324961 A1
(43) Pub. Date: Oct. 30, 2014

(54) METHOD AND SYSTEM FOR TRANSMITTING DATA

(71) Applicant: Skärmtroll AB, Lund (SE)

(72) Inventors: Magnus Hollström, Lund (SE); Petter Ericson, Malmö (SE)

(73) Assignee: Skärmtroll AB, Lund (SE)

(21) Appl. No.: 14/365,612

(22) PCT Filed: Dec. 14, 2012
(86) PCT No.: PCT/SE2012/051397

§ 371 Date: Jun. 13, 2014

Related U.S. Application Data
(60) Provisional application No. 61/578,263, filed on Dec. 21, 2011.

(30) Foreign Application Priority Data
Dec. 16, 2011 (SE) 1151213-4

(51) Int. Cl. H04L 29/06; G06F 17/30; G06F 3/0488

(52) U.S. Cl. CPC H04L 67/42; G06F 3/0488; G06F 17/30861
USPC 709/203

(57) ABSTRACT

The present invention comprises in one aspect a method for transmitting, via a client 12 having a display 11, data from a device 10 to a database 14, wherein said data is divided into a plurality of data items, said method comprising: arranging the device 10 by the display; extracting a data item of the plurality of data items, wherein said data item is to be transmitted from the device 10 to the database 14; inputting, to the client, an input corresponding to a data item; transmitting said input from the client 12 to the database 14; transmitting an output corresponding to the input from the database 14 to the client 12; displaying, on the display 11 of the client 12, the output such that the device 10 can read said output; reading the output by means of a reader 16 of the device 10; comparing, in the device 10, the output with said extracted data item of the plurality of data items; and if the output corresponds to the extracted data item of the plurality of data items, acknowledging that said extracted data item has been transmitted from the device 10 to the database 14. The present invention comprises in a second aspect a system for transmission of data from a device 10 to a database 14, wherein the data is divided into a plurality of data items.

### FIELD OF TECHNOLOGY

The present invention relates to a method and system for transmitting data, in particular a method for transmitting data from a device to a database via a client having a display.

### BACKGROUND

Data communication between a device and a service, such as a web site located on a server, through a client, such as a computer, is widely used today. One field of application is to communicate from a device, such as a mobile phone, a toy, a watch, a GPS, a heart rate monitor or a security toke, an ID of the device, or a log of the device, such as a log comprising offline activities of the device, etc.

There are a number of different communication standards which may be used to communicate data from a device to a computer for further transmission to a e.g. a web service. For example, data can be transferred by connecting the device to a specific interface on the computer. Existing communication standards includes Bluetooth, USB, and RFID. These communication standards typically require a dedicated driver software to be run on the computer. Due to the wide range of different existing communication standards, a device is rarely connectable to all types of computers since different computers are adapted to different communication standards.

Some communication standards, such as USB and micro-USB, also require that a dedicated communication hardware is configured between the computer and the device. This feature introduces further complications to the user.

Moreover, the user of the device most often needs to have an understanding of how to operate the particular communication interface.

Altogether, the presently known communication standards are complicated, costly and time-consuming. Thus, there is a need for a more user-friendly, less costly and less complex method for communicating data.

### SUMMARY OF THE INVENTION

One purpose of the present invention is therefore to provide a communication method for transferring data from a device to a client, such as a computer. In particular, one purpose of the present invention is to provide a user-friendly, cheap and simple method for communicating the data.

According to a first aspect, the present invention is a method for transmitting, via a client having a display, data from a device to a database, wherein said data is divided into a plurality of data items, said method comprising:

arranging the device by the display;

extracting a data item of the plurality of data items, wherein the data item is to be transmitted from the device to the database;

inputting, to the client, an input corresponding to a data item;

transmitting said input from the client to the database;

transmitting an output corresponding to the input from the database to the client;

displaying, on the display of the client, the output such that the device can read said output;

reading the output by means of a reader of the device;

comparing, in the device, the output with said extracted data item of the plurality of data items;

if the output corresponds to the extracted data item of the plurality of data items, acknowledging that said extracted data item has been transmitted from the device to the database.

The present invention is based on the concept of utilizing the display of the client to transfer data from the device to a database. A client, such as, a computer (e.g. a stationary computer, a laptop, or a touchpad), a mobile phone, or a smartphone, normally comprises a display. The display may e.g. be a LCD screen. The display may e.g. be a touch screen. Since the display of the client is used to transfer data from a device to a database, there is no need for installing any extra hardware for being able to transfer data from the device to the client and the database.

A display is an interface that is well known and generally understood by computer users today. Hence, a user does not need any specific knowledge of how to operate the communication interface in order to transfer data from the device to the client.

Further, by dividing the data into a plurality of data item, the data is transmitted sequentially by transmitting each data item individually. This is advantageous for example if the data is to be transmitted over a low bandwidth. Another advantage is that errors may be detected and corrected or dealt with continuously during a data transmission. Thus, an error may be corrected shortly after it has occurred, even during a transmission of a large amount of data. Yet another advantage is that the feature enables additional data to be transmitted continuously during the data transmission. Each individual transmission of a data item may contain additional data. Furthermore, a more fail-safe method of transferring data may be achieved since a transmitted data item is checked such that is has correctly been transmitted to the database.

The data may be a unique ID of the device, a log such as an offline activity log, information regarding the user, information regarding battery capacity or battery level, health monitoring information (such as a heart rate), exercise log, etc.

The data may be data received by the device from an external source (connection to other devices or broadcasting services), the data may have been entered into the device by the user, or the data may have been created within and by the device.

The client could be a computer (e.g. a stationary computer, a laptop, or a touchpad), a mobile phone, a smartphone, or any other client utilizing a display.

The database could be located on the client. For example the database may be located in a memory of the client.

The database could alternatively be located outside the client. For example the database may be located on a server. The client could be connected to the server via a network. The network may be a wireless or wired network or a combination thereof.

The step of inputting, to the client, may be achieved by a mechanical input. The mechanical input may be achieved by means of an inputting means of the client. The inputting means may be located in the client or in connection to the client.

The inputting means of the client could be a touch screen. Further, the device may comprise outputting means for interacting with the touch screen. The outputting means of the device could emulate touches on a touch screen using e.g. spatial, frequency or hybrid technologies.

The inputting means of the client could be a near-field signal reader. Further, the device may comprise outputting means for outputting a near-field signal.

The inputting means of the client could be a Bluetooth signal reader. Further, the device may comprise outputting means for outputting a Bluetooth signal.

The inputting means of the client could be an RFID signal reader.

Further, the device may comprise outputting means for outputting an RFID signal.

The inputting means of the client could comprise one or more in the group of: keyboard, mouse, trackball, touch screen, game controller, and joystick. The inputting could be a user-performed inputting, which also is a form of mechanical input.

By the term “arranging the device by the display” is meant that the device is arranged either in direct connection to the display, or sufficiently near the display such that the reader of the device can read the output.

The device may be arranged fixedly in connection to the display. This feature may be achieved by means of a suction cup, a micro suction or an adhesive material. Alternatively, the device may be arranged at a distance from the display, e.g. by a user holding the device sufficiently near the display such that the device can read out output displayed on the display.

The device may be arranged on a predetermined read-out area on the display. Alternatively the read-out area may be indicated by a physical indication on the display or the read-out are may be indicated by an indication on a web page which is displayed on the display. The displaying of an output may be performed within the read-out area.

The display could be a conventional screen for a computer such as a LCD display. Alternatively, the display may be a display which is able to receive input, i.e. a touch screen.

The client may define a read-out area by sensing the device arranged on the display. The displaying of an output may then be performed within the read-out area.

By the term “acknowledging” is meant that the device performs an operation upon the conclusion that the output corresponds to the extracted data item of the plurality of data items. The performed operation could comprise flagging the extracted data item, deleting the extracted data item from the memory of the device, transmitting data to the client, such as an “transmission OK” message, initiate a transmission of another data item, starting a timer for a time during which the device should be idle or awaiting a new request from the client, a combination of operations, etc.

The method may further comprise:

transmitting, from the database to the client, a request output for the data item of the plurality of data items to be transmitted;

displaying, on the display of the client, the request output such that the device can read said request output; and

reading said request output by means of the reader of the device.

Hence, the transmission may start with a request from the client. The request may comprise information of which data to transmit from the device. This feature provides advantages such as that the client may request which type of data that should be transmitted. The client could for example request that an ID of the device is transmitted before any other data is transmitted from the device.

The method may further comprise deleting, in the device, the extracted data item which has been acknowledged to have been transmitted from the device to the database. An advantage with this feature is that the device does not store unnecessary data which already has been transmitted. Thus, memory capacity can be utilized for other data. This feature is suitable for data which is to be transmitted only once, such as data comprising temporary information. Temporary information could be e.g. an activity log or a connection log.

The method may further comprise displaying, on a display of the device, a symbol corresponding to the data item to be transmitted. An advantage with this feature is that a user may perform an input based on the displayed symbol. For example, the user may perform an input on the client display by drag-and-dropping a symbol on the client display corresponding to the symbol displayed on the display of the device. Thus, the symbol displayed on the device may instruct a user on how to perform an input to the client.

The method may further comprise:

if the output does not correspond to the extracted data item of the plurality of data items, transmitting an error code from the device to the client and optionally further from the client to the database.

By the error code, the device may be informed that the last data item which were to be transmitted has not been correctly transmitted. The error code may be transmitted to the client by an input corresponding to an error code. Such an input could be performed by e.g. a user or by an outputting means of the device. The client may perform a further operation as response to receiving an error code. The operation could be that the client performs an output corresponding to the last output (which was not transmitted correctly).

The method may further comprises that extracting a data item, inputting an input, transmitting the input, transmitting an output, displaying the output, reading the output, comparing the output with said extracted data item are repeated until each data item of the plurality of data items has been acknowledged to been transmitted from the device to the database. Thereby, the whole data has been transmitted.

According to a second aspect, the present invention is a system for transmission of data from a device to a database, wherein the data is divided into a plurality of data items, said system comprising:

a device comprising a reader;

a client comprising a display;

a database in connection to the client;

wherein said device is adapted to be arranged by the display;

wherein said device is adapted to extract a data item of the plurality of data items to be transmitted from the device to the database;
wherein said client is adapted to receive an input corresponding to a data item;

wherein said client is adapted to transmit said input from the client to the database;

wherein said database is adapted to receive said input from the client;

wherein said database is adapted to transmit an output corresponding to said input;

wherein said client is adapted to receive, from the database, the output corresponding to said input;

wherein said client is adapted to display, on the display of the client, the output corresponding to said input;

wherein said device is adapted to read the output by means of the reader;

wherein said device is adapted to compare the output with said extracted data item of the plurality of data item; and

wherein, if the output corresponds to the extracted data item of the plurality of data items, the device is adapted to acknowledge that said extracted data item has been transmitted from the device to the database.

The system may further comprise that said device is adapted to input, to the client, an input corresponding to an data item.

The features, alternatives and advantages disclosed previously in connection to the first aspect of the present invention also apply to this second aspect of the present invention.

### BRIEF DESCRIPTION OF DRAWINGS

Preferred embodiments of the present invention will now be disclosed in detail with reference to the drawings.

FIG. 1a schematically illustrates an embodiment of a system, for transmission of data from a device to a database via a client, according to the present invention.

FIG. 1b schematically illustrates an embodiment of an alternative device and client to be used in the system of FIG. 1a.

FIG. 1c schematically illustrates an embodiment of an alternative client to be used in the system of FIG. 1a.

FIG. 2 illustrates a communication between the client and the device of the system of FIG. 1a.

FIG. 3 illustrates a front and back of a device according to the present invention.

FIG. 4 illustrates a display of a client together with a device according to the present invention.

FIG. 5 illustrates a method for transmitting data from a device to a database according to the present invention.

### DETAILED DESCRIPTION OF PREFERRED EMBODIMENTS

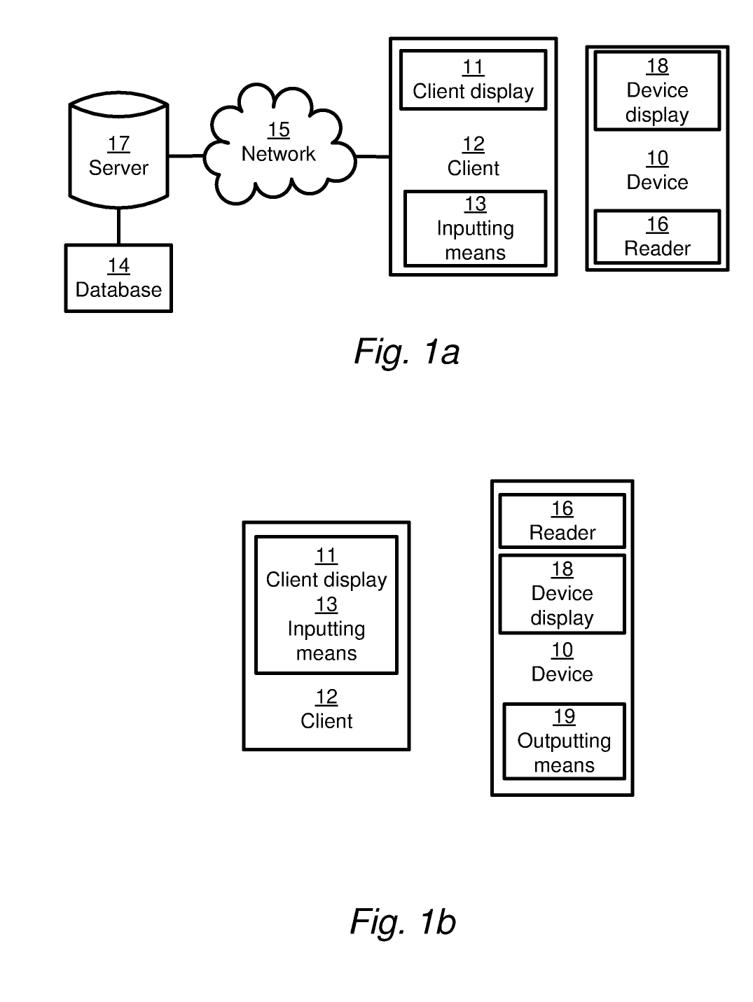

An embodiment of a system for transmission of data from a device 10 to a database 14 via a client 12 is illustrated in FIG. 1a. The system comprises the device 10, the client 12 and the database 14.

The device 10 comprises a reader 16 and optionally a device display 18.

The client 12 comprises a client display 11 and an inputting means 13. The client may e.g. be a laptop, a touchpad or a smartphone.

A purpose of the present invention is to enable a user-friendly and easy to perform transmission of data from the device 10 to the database 14. This is achieved by alleviating the need for any extra communication interfaces. Instead of an added communication interface, the present invention utilizes the client display 11. Thus, no extra communication hardware between the device 10 and the client is needed.

The data which is to be transmitted from the device 10 to the database 14 may be any data located in the device 10. The data is not limited to any particular type of data. Examples of types of data is a log over activities which the device 10 has performed since it last was connected, a unique ID for the device 10, information about the current capacity of a battery in the device 10, a log over recent connection activities for the device 10, etc. Depending on embodiment, it may be desired to transfer different types of data.

The general concept of the present invention is that the data is transferred from the device 10 to the database 14 by utilizing the already present client display 11. The device 10 is arranged by the client display 11. An input corresponding to a data item is made via the inputting means 13 of the client 12 to the client 12. The data item is a part of the data which is to be transmitted from the dev ice 10 to the database 14. Examples of inputting means 13 are: a keyboard; a computer mouse; a joystick; a game controller; a digital pen; a trackball; a pointer for touch screens; a touch screen for receiving input from human fingers etc. Common for all these examples of inputting means are that they may be operated by a user. If so the data item, or a representation of the data item to be inputted to the client is displayed on the device display 18 and thereafter the user inputs the data item or the representation of the data item to the client 12 via the inputting means 13 of the client 12. Below, in connection with FIG. 1b, an alternative method for inputting a data item to the client will be described.

According to the embodiment shown in FIG. 1a, the database 14, to which the data is to be transferred to, is located in connection to a server 17. The database 14 could be located on a memory (not illustrated). The server 17 is connected to the client 12 through a network 15. The network 15 could be a wireless or wired network or a combination thereof. Data which is inputted to the client 12 is transmitted to the database 14 via the network 15.

From the database 14, the transmitted data is accessible to the client 12 or other data processors connected to the network and having access privileges to the database 14. The client 12, or any other data processor having access to database 14, may request data from the database 14 for analysis or other use.

In order to acknowledge that the correct data has been transmitted, the database 14 returns an output corresponding to the input. The client 12 displays a representation of the output on the client display 11. The device 10 reads out the representation of the output displayed on the client display 11 by means of the reader 16 and compares the output to the data item which were to be transmitted. If the read out from the reader 16 corresponds to the data item which was to be transmitted, the device 10 acknowledges that the data item actually has been transmitted as desired.

The whole data, which comprises a plurality of data items, may thus be transmitted by sequentially transmitting every single data item. Each transmission of a data item is acknowledged by the device. The acknowledgement could comprise that the specific data item is deleted from the device 10. Alternatively, the acknowledgement could comprise that the concerned data item is flagged by the device 10 such that the device 10 knows that the data item has been transmitted to the database 14.

Another advantage achieved by the sequential transmission and acknowledgement is that the data may be transmitted on a channel having a low bandwidth. An example of such a channel is the interface between a touch screen (being the display 11) and the reader 16 and outputting means 19 of the device 10. The touch screen has a relatively low update frequency, thus the channel over which the reading of an output on the screen has a relatively low bandwidth. Analogously, an input (performed by the outputting means 19 or alternatively a user) is transmitted over a low bandwidth channel.

Since the data items are acknowledged, it is secured that the data item has been correctly transmitted. Thus, the input, corresponding to the data item to be transmitted, must not be limited to be performed by a reliable communication channel. Thus, the input could be performed by an inputting means 13 which is adapted to a user-performed input. A user-performed input is a relatively unreliable communication channel due to the risk of the user doing wrong when inputting the data item via the inputting means 13. A conventional communication channel, such as a USB wire or Bluetooth connection, is much more reliable in comparison.

In FIG. 1b an alternative embodiment of the device 10 is shown. According to this embodiment the device 10 comprises a reader 16, a display 18 and an outputting means 19. The device 10 is in this embodiment arranged to input an input to the client 12 by means of the outputting means 19. The outputting means 19 is a capacitive or inductive means being arranged for performing an input on a touch screen. An example of such an outputting means 19 is disclosed in the article TUIC: Enabling Tangible Interaction on Capacitive Multi-touch Display (Yu et al, CHI 2011, May 7-12, 2011, Vancouver, BC, Canada). According to this embodiment, the input of the outputting means 19 of the device 10 is received via the inputting means 13 of the client 12 being a touch sensitive client display 10, e.g. a touch screen. Hence, the inputting means 13 and the client display 10 are formed together in one component. This type of outputting means 19 performs a mechanical interaction with the client 12. The mechanical interaction is much more unreliable than conventional communication interfaces, such as Bluetooth connections or wired connections, as disclosed above. However, by the transmission method according to the present invention, an outputting means 19 performing a mechanical input to the inputting means 13/the client display 11 may be used. The outputting means 19 could of course also be an external outputting means which is connected to the device.

In FIG. 1c an alternative embodiment of the client 12 is illustrated. Here, the database 14 is comprised within the client 12.

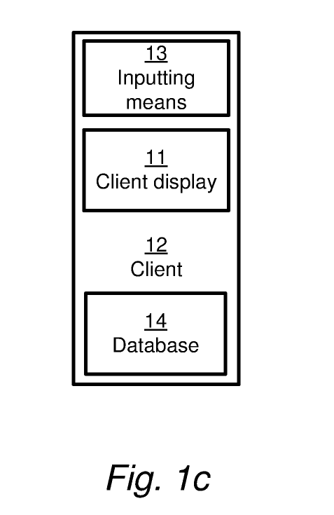

The transmission of a data item will now be explained in detail with reference to FIG. 2. The data 24 is stored on a memory of the device 10. The data 24 is divided into a plurality of data items 25, 26, 27, 28, 29. Each of the data items 25, 26, 27, 28, 29 may comprise differently sized parts of the data.

In order to transmit the data 24, the device is arranged by the display of the client 12. In the device 10, one data item of the plurality of data items 25, 26, 27, 28, 29 is extracted. The one data item must not be any particular in the plurality of data items 25, 26, 27, 28, 29. In this example, the data item 27 is extracted. Hence, the data item 27, which comprises the data “J”, is to be transmitted from the device 10 to the database 14.

Next, an input 20 to the client 12 is performed. On a display of the device 10, a symbol corresponding to the data item 27 is displayed. A user mechanically performs the input 20 by means of an inputting means. In this embodiment, the inputting means is a computer mouse. The inputting means could however be any suitable inputting means (examples of such are previously disclosed). The input 20 is performed by drag-and-drop on the display, i.e. clicking with a cursor on an object of the display and dragging, by means of the computer mouse and cursor, the object to a particular area and dropping the object there. The input could be performed by means of a web site which is displayed on the client display 11. By the drag-and-drop action, the client 12 receives the input 20. The input 20 corresponds to a data item. Note however that due to potential error during the input process, due to e.g. a wrong input made by the user, it is not guaranteed that the input 20 corresponds to the data item 27 to be transmitted.

The input 20 is transmitted from the client 12 to the database 14.

The client 12 displays an output 22 on the display 11 of the client 12. The output 22 has been transmitted from the database 14 to the client 11, and corresponds to the input 20 previously transmitted from the client 12 to the database 14. The output 22 is displayed such that the device 10 can read the output 22. The device 10 reads the output 22 from the display 11 by means of a reader 16 of the device 10. The reader 16 is an optical reader. The output is in a form such that the reader 16 can read the data. Such form is for example a graphical image, an intensity modulation, a color modulation a pattern, etc. The output 20 is either displayed on a predetermined read-out area or at a random location by which the device 10 is arranged for reading the output 22.

In the device 10, the output 22 is compared to the extracted data item 27. The comparison can be performed by means of a processor in the device 10. If the output corresponds to the extracted data item 27, the device 10 acknowledges that the extracted data item 27 actually has been transmitted from the device 10 to the database 14. That means that the input 20 was correct and did in fact correspond to the data item 27. The acknowledgement could comprise that the specific data item is deleted from the device 10. Alternatively, the acknowledgement could comprise that the concerned data item is flagged by the device such that the device 10 knows that the data item has been transmitted to the database 14. The acknowledgement could alternatively, or also, comprise that an acknowledgement data is transmitted to for example the client 12.

If the output 22 corresponds to the extracted data item 27, the steps of extracting a data item, inputting an input, transmitting the input, transmitting an output, displaying the output, reading the output, comparing the output with the extracted data item are repeated, but with another data item, e.g. data item 29. The method is repeated in this way until each data item of the plurality of data items 25, 26, 27, 28, 29 has been acknowledged to been transmitted from the device 10 to the database 14.

In one embodiment, where the data 24 is a unique ID, the method is only repeated until it may be concluded, e.g. by the client 12, which unique ID the already transmitted and acknowledged data items belongs to. For example, if it may be concluded that the data 24 can only be one of a plurality of possible unique ID:s after transmittal of data items 25, 26, and 27, then there is no need for transmittal of the remaining data items 28 and 29. When there is only one possible unique ID left, it may be displayed, on the display 11 of the client 12, an output corresponding to a stop command meaning that the device 10 does not need to send any more data items of the data 24. Alternatively, the output could correspond to a new output request 23 requesting a new data or new type of data to be transmitted from the device 12 to the database 14. The features of this embodiment could, as understood, also apply to other types of predictable data besides unique ID:s.

Returning to the comparison between the output 22 and the extracted data item 27; if the output 22 does not correspond to the extracted data item 27, an error has occurred during the transmission of the data item 27. It could be that the user or outputting means of the device has performed the input 20 incorrectly. It could alternatively, or also, be that the input 20 and/or output 22 has been erroneously transmitted between the client 12 and the database 14.

If the output 22 does not correspond to the extracted data item 27, the device 10 transmits an error code from the device to the client 12 and possible further to the database 14. This is preferably performed in the same way as a data item is transmitted from the device 10 to the client 12 and further to the database 14 as described above. The error code indicates that the data item 27 has not been transmitted correctly. The system could be configures such that the client 12 is informed by the error code that the next data item which is transmitted is the data item 27 again. The input 20, which was potentially incorrect, could also or alternatively be deleted from the database 14.

In one embodiment, the transmission of data 24 is initiated by the client 12 displaying a request output 23 to the device 10. The request output 23 has been transmitted from the database 14 to the client 12. The request output 23 comprises a request for the particular data item 27. The device 10 reads the request output by means of the reader 16 of the device 10. Hence, the client 12 and/or database 14 can decide which data item to be extracted. Alternatively, the request output 23 could concern a particular data or type of data instead of a particular data item. The output request 23 could for example comprise a request for an ID of the device 10.

In one embodiment, the output 22 is an encrypted data which is decrypted by the device 10 before it is compared to the data item 27 which was to be transmitted. The encryption may be performed by the client 12, the server 17 or any other connected suitable component. The encrypting component and the device 10 share the same encryption/decryption key such that the device 10 can correctly decrypt the encrypted output 22.

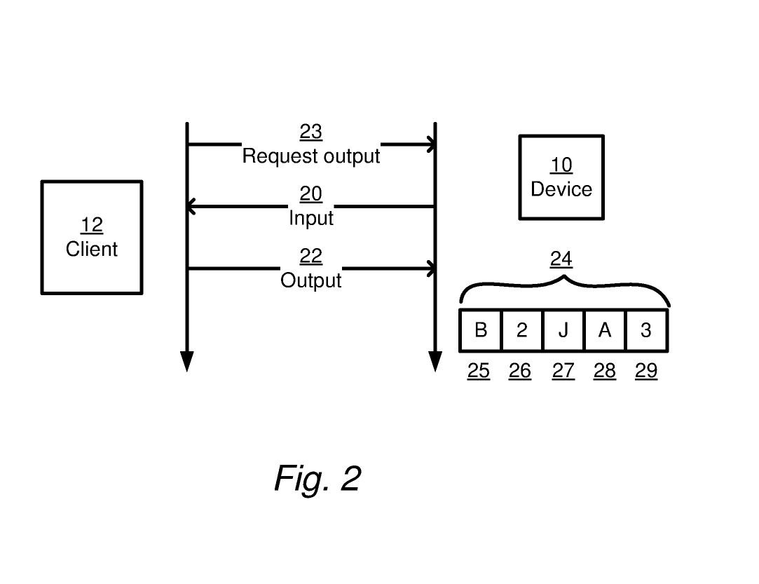

In one embodiment of the present invention, the device 10 is a toy. The device 10 according to this embodiment is illustrated in FIG. 3. The front of the device 10 is illustrated to the left and the back of the device 10 is illustrated to the right in the figure.

The device 10 according to this embodiment comprises, as previously disclosed, a display 18. The device 10 further comprises a button 32 and a speaker 34. The display 18, the button 32 and the speaker 34 form a communication interface between the device 10 and a user. The user may interact with the device 10 by pushing the button, receiving an output by the speaker 34 and receiving information by the display 18.

The device 10 comprises a processor for processing data, and a memory for storing data. For example, in the memory of the device 10, a unique ID could be stored. The device 10 further comprises a battery.

The device 10 comprises a reader 16 for reading data. The reader 16 is an optical sensor adapted to read images or video streams. The reader 16 can read data in form of an image, i.e. an output, on a display 11, such as a computer screen. Further, the processor is adapted to process the read image such that the comprised data may be extracted from the image.

The reader 16 could also read data from other toys which preferably has the similar construction as the device 10. Moreover, the other toys could also read data from device 10, for example by means of reading an image form the display 18.

The device 10 has an outputting means 19 by which the device 10 can emulating touches on a touch screen, such as a capacitive touch screen. An example of such an outputting means 19 is described more in detailed in the article TUIC: Enabling Tangible Interaction on Capacitive Multi-touch Display (Yu et al, CHI 2011, May 7-12, 2011, Vancouver, BC, Canada)

The device 10 has a suction cup 39 for arranging the device 10 to e.g. a screen. Alternatively, the device 10 may be arranged by e.g. a micro suction or adhesive material for fixed arrangement. The arrangement could be fixed.

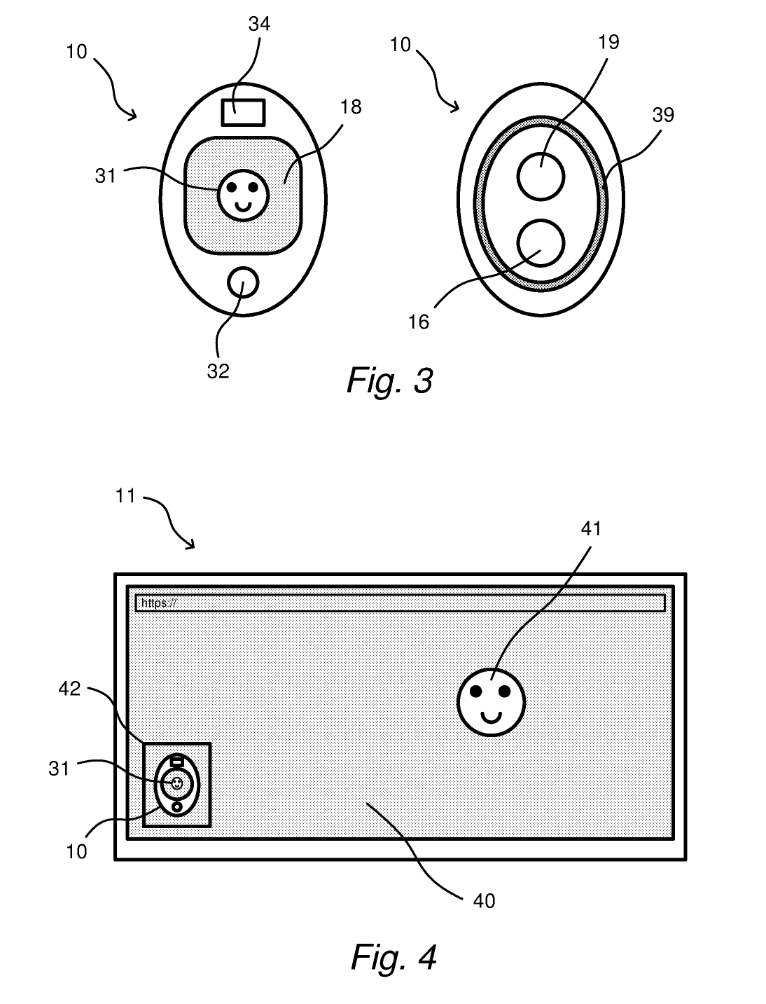

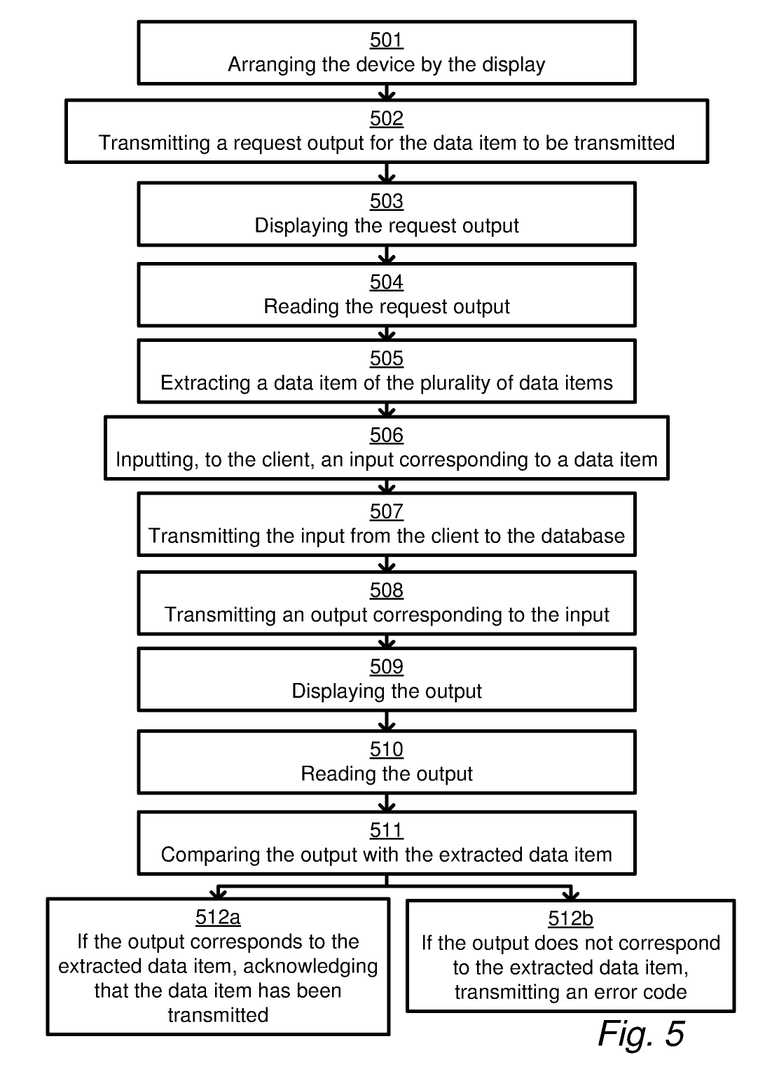

In one embodiment, illustrated by FIG. 4, the transmitting of data from the device 10 to the database 14 is formed as a game. The device 10 is a toy, as the device 10 disclosed in FIG. 3. The device 10 is attached on the client display 11. The device 10 displays a device avatar 31 which represents the user playing the game. One purpose of the game is to enable the user to interact in an online virtual world with its device avatar 31. To be able to do so, data regarding the device 10 is transmitted to the database 14. From the database 14, the client 12 or other connected data processors, may retrieve the data. The data is transmitted according to the previously disclosed method. The device 10 is attached to the client display 11 at a predetermined read-out area 42 by means of the suction cup 39. Other forms of attachments, including a user holding the device at a distance from the client display 11, are also feasible.

The online virtual world is displayed as a web page 40 by client 12 on the display 11 of the client 12. The user is represented in the online virtual world by a virtual avatar 41. One or more predetermined read-out areas 42 can be displayed on the client display 11.

In another embodiment, the device may be attached anywhere on the client display 11. The location of the device 10 is recognized by the client 12 and any output which is intended to be read by the device 10, is displayed at the location. Thus, the client 12 arranges the read-out area 42 after the device 10 has been arranged on the client display 11. The location of device 10 may be recognized if the client display 11 is e.g. a capacitive touch screen and the device 10 has an outputting means 13 which outputs an output to the touch screen. The output from the outputting means 13 could be specifically designed to be a “here I am”-signal for the client 12 to recognize. For example, in one embodiment the client display 11 is a projective capacitive screen. The device 10 will have one or several conductive components, i.e. outputting means, on its back. The footprint of these components output signal are detected by the projective capacitive screen and may by the client 12 be clearly distinguished from a human finger touching the screen. The conductive components can be passive metal components. The footprint could be different for different devices.

In other embodiments, the read-out area 42 could be defined by a user touching a touch screen at an area where the user prefers the read-out area 42 to be. The read-out area 42 could alternatively be defined by the user by means of the computer mouse or other similar inputting means for interacting with a computer.

In one embodiment, the data is a unique ID by which e.g. the client 12 or a server 17 can identify the device. The database 14 comprises a list over all device ID:s, possible correlated to information concerning the user (such as age, name, gender) information about the device (such as a log over recent connections, how many times the device has been connecter, which country or region the device is configured for, etc.). Thus, by transmitting the unique ID to the database 14, the device 10 and user may be identified. This transmittal of data may thereby replace a conventional login to a web site, where a user puts in e.g. his/her e-mail address and a password for accessing a web page.

According to one embodiment, after having identified the device 10, and possible the user connected to the device, the client 12 may display a web page specifically directed to the device 10, or its user. Such a web page could display an online virtual world where the device avatar 31 is represented by a virtual avatar 41. Through the virtual avatar 41, the user can for example explore the online virtual world and interact with friends which are also connected to a web service providing the online virtual world. The virtual avatar 41 can be leveled with new objects, abilities and features by the user completing missions. The upgrade of the virtual avatar 41 may be transmitted to the device avatar 31 by reading data with the device 10. The data is output by the client 12 at the read-out area 42.

In one embodiment, data items which are to be transmitted according to the present invention are represented by symbols such as fruits or vegetables. The symbols are shown in the online virtual world. On the device display 18, a specific symbol is shown when the device 10 is attached to the client display 11. The user then drag-and-drops the corresponding specific symbol in the online virtual world, displayed at the web page 40 on the client display 11 on to the read-out area 42. Then, the device 10 can read the symbol and act upon it. For example, if the specific symbol is an apple, the device 10 changes the appearance of the device avatar 31 from having a neutral face to a happy face (since he likes apples). The drag-and-drop action can correspond to the input 20 to the client 12 which represents the data item. Thus, the user is provided with the conception that he/she is feeding the device avatar 31, while he is actually simultaneously provides data to the database 14 which identifies the device 10. Hence, the present method provides a user-friendly and simple login concept by which the user is not aware of that identification of the device 10 going on while the user is performing operations on the web page.

In one embodiment, the device 10 is operable in two modes. One is an attached mode when the device 10 is attached to the client display 11 and one detached mode when the device 10 is not attached to the client display 11. In the attached mode the actions performed by the device 10 are triggered by output requests 23 from the client 12. In the detached mode the actions performed by the device 10 are triggered by an application program embedded in the device 10 and/or by a user.

When the device 10 is removed from the client display 11, the user can play with it offline. Two toys, each being a device 10, can be held against each other such that they can communicate and exchange identity codes to create a personal connection between the users. A reader of a first device can for example read out an image from a display of a second device. The image could be an object, such as a sword, which the user of the first device has obtained in the online virtual world. Thus, users may share exchange objects outside the online virtual world.

In one embodiment, the client 12 extracts updates made offline when the device 10 is attached to a client display 11. The updates are extracted by the client 12 sending a request output 23 requesting data comprising e.g. a log over recent activities performed in a detached mode of the device 10. The data is transmitted to the client 12 and the database 14 by the method according to the present invention. If e.g. a recent connection has been made with another toy, being a device 10, the client 12 will correlate the new connection in the database 14 to the connected device 10. This is of course performed after the device 10 has been identified in the database 14 according to previously disclosed embodiments. The new connection may then be part of a virtual network of the user. Further, the user and his/her new connection will be part of each other's social network and can meet and interact with each other in the online virtual world through their virtual avatars.

FIG. 4 illustrates the method according to the present invention for transmitting data 24, divided into a plurality of data items 25, 26, 27, 28, 29, from a device 10 to a database 14. The method is performed in a system comprising the device 12, the client 12 and the database 14, according to any of the previously disclosed embodiments. The method comprises:

arranging 501 the device 10 by the client display 11;

extracting 505 a data item of the plurality of data items 25, 26, 27, 28, 29, wherein said data item is to be transmitted from the device 10 to the database 14;

inputting 506, to the client 12, an input 20 corresponding to a data item;

transmitting 507 said input 20 from the client 12 to the database 14;

transmitting 508 an output 22 corresponding to the input 20 from the database 14 to the client 12;

displaying 509, on the client display 11, the output 22 such that the device 20 can read said output 22;

reading 510 the output 22 by means of a reader 16 of the device;

comparing 511, in the device 12, the output 22 with said extracted data item of the plurality of data items 25, 26, 27, 28, 29; and

if the output 22 corresponds to the extracted data item of the plurality of data items 25, 26, 27, 28, 29, acknowledging 512a that said extracted data item has been transmitted from the device 12 to the database 14.

Previously disclosed features, alternatives and advantages apply also to this method.

The method may further comprise:

transmitting 502, from the database 14 to the client 12, a request output 23 for the data item of the plurality of data items 25, 26, 27, 28, 29 to be transmitted;

displaying 503, on the client display 11, the request output 23 such that the device 12 can read said request output 23; and

reading 504 said request output 23 by means of the reader 16 of the device 12.

These features, their alternatives and advantages are previously disclosed.

As previously disclosed in embodiment, the method may comprise that if the output 22 does not correspond to the extracted data item, an error code is transmitted 512b to the client 12.

### SPECIFIC EXAMPLES OF EMBODIMENTS

In the following, a number of detailed examples are presented. The examples illustrate different uses of the method according to the present invention.

### Example 1

### A Device Communicates New Data

1. A user opens a web site
2. A computer (a client) continuously outputs a connection output at a read-out area
3. The device is attached on the read-out area on the computer display
4. The device detects the connection output
5. The device displays, on its display, a symbol encoding a data item which is part of a plurality of data items forming data comprising <my ID, new physical connection>
6. The user inputs the symbol in the computer
7. The computer outputs the input symbol as an output at the read-out area
8. The device reads the output symbol and acknowledge that the symbol is correct
9. The steps 5-8 are repeated until all data items composing the data has been acknowledged
10. The device displays an <OK> symbol on its display
11. The user makes an input corresponding to the <OK> symbol into the computer
12. The computer outputs <OK> at the read-out area
13. The client stores the <new physical connection> data in a database

### Example 2

### Client Identifies a Device By a Cookie and Communicates <Mission 2> Data

1. A user opens a web site
2. A cookie with device ID is stored in a memory of the client and detected by the client
3. The client continuously displays, on its screen, an output comprising <connection, ID 1>
4. The device is attached to the client screen on a read-out area
5. The device reads the <connection, ID 1> output
6. The device displays, on its display, a symbol encoding a data item which is part of a plurality of data items forming data comprising <ID 1>
7. The user inputs the symbol in the client
8. The computer outputs the input symbol as an output at the read-out area
9. The device reads the output symbol and acknowledge that the symbol is correct
10. The steps 6-9 are repeated until all data items composing the data has been acknowledged
11. The device displays an <OK> symbol on its display
12. The user makes an input corresponding to the <OK> symbol into the client
13. The client outputs <OK> at the read-out area
14. The client outputs an output corresponding to data comprising <mission 2> at the read-out area
15. The device reads the output and stores the <mission 2> data
16. The device displays, on its display, a symbol encoding a data item which is part of a plurality of data items forming data comprising <mission 2 received OK>
17. The user inputs the symbol in the client
18. The client outputs the input symbol as an output at the read-out area
19. The device reads the output symbol and acknowledge that the symbol is correct
20. The steps 16-19 are repeated until all data items composing the data <mission 2 received OK> has been acknowledged
21. The service outputs an <OK> data as an output at the read-out area

### Example 3

### Service has New Broadcast Data <Object 5> to Communicate

1. A user open a web site
2. A computer continuously communicates an output corresponding to data comprising <object 5>
3. The device is attached by the read-out area on the computer screen
4. The device reads the <object 5> data output
5. The device stores the <object 5> data in its memory
6. The device displays “broadcast received—please detach” to user on the display of the device
7. The user detaches the device from the computer screen
8. The next time the device is connected to the web page, the device informs the computer, by the method in example 1, that it has received object 5

### Example 4

### Create Online Connections from Physical Connections

In this example, the device is further arranged to send data via e.g. a LED.

Two users meeting physically can create a connection by holding their respective devices back-to-back, and possible further pressing a button. The devices exchange their ID by LED communication. At a computer, the device is thereafter arranged on the computer screen. The ID of the previously connected device (the other user's device) is transferred to the computer and database using the method in example 1. An online connection is established between the two users. This feature can be used to limit or filter connections on a social network to physical connections only.

### Example 5

### A Moving Object (E.G. An E-Pet) between the Online Virtual World and the Device

The device is arranged on the computer screen and identified as in example 1. The user uses the computer mouse to drag-and-drop an e-pet on a website displayed on the computer screen to the read-out area where the device is arranged. The computer outputs data corresponding to an ID representing the e-pet by means of an output at the read-out area. The e-pet disappears from the web site on the computer screen and is now visible on the device display.

### Example 6

### Sharing Objects between Users

An object stored in the device according to example 3 can be shared with a second user by connecting the devices according to example 2. The shared object can be transferred to the second users online virtual world when the second user arrange the device at a computer screen according to example 1.

### Example 7

### Device Becoming a Live E-Pet when Arranged on the Screen

When placed on the screen and identified according to example 1, an impression that the device can come to life can be provided on the screen by animated parts being perceived to be grown from the device.

For example, the device is a turtle shell. When placed on screen the head, tail and legs will be displayed adjacent to and around the device but on the web site displayed on the screen.

### Example 8

### Evolving E-Pet with New Abilities, Features and Objects

Different examples of requirements which could lead to new abilities, features or objects are listed below.

### Example 8a

Evolving by activities in the online virtual world with the device attached to the screen. This is achieved by detecting that the device is connected to the screen for an uninterrupted period of time according to 10.

### Example 8b

Evolving by activities offline creating physical connections with other devices.

### Example 8c

Evolving by attaching the device to new screens (computers, phones, tablets etc.).

### Example 8d

Evolving by a user interacting with the device when it is not attached to the computer (by means of a display, a button, a speaker, etc. on the device).

### Example 8e

Evolving by performing one of the above examples within a certain time period or at a certain time.

It is understood that the device 10 may be other types of devices than a toy. For example, the device 10 could be a security device for logging into a web site for e.g. a bank. The input could be different parts of a security token to input to the database 14 located on a server 17 at the web site.

Other examples of embodiments are that the device 10 is a Bluetooth device communicating a PIN code to enable auto pairing, a heart rate monitor communicating heart rate data, or a GPS communicating location data.

The skilled person realizes that the client display of the above mentioned embodiments of the system and the method may be exchanged for another element commonly used in a client. The display could for example be exchanged for an A/D transceiver such as a microphone, speaker, etc. If an A/D transceiver is used, the device has a microphone for reading the output which the client transmits trough the A/D transceiver. The output would in that case be in form of a sound. The input to the client would in this embodiment also be in form of a sound provided by the device and received by the inputting means, i.e. a microphone, of the client.

Another example is that a camera connected to the client is utilized as inputting means for inputting to the client. The device could in this embodiment have a cord that can be attached to the camera lens. A light source, e.g. a LED, in the device modulates light which forms an input. The input is read by an inputting means of the client in form of a camera. The light source of the device could be arranged directly against the camera lens or alternatively be indirectly connected via a light guide, such as a light transmitting cord.

A person of ordinary skills in the art realizes that different features of the disclosed embodiments may be combined to form other embodiments.

In summary, the present invention comprises in one aspect a method for transmitting, via a client 12 having a client display 11, data 24 from a device 10 to a database 14, wherein said data 24 is divided into a plurality of data items 25, 26, 27, 28, 29, said method comprising: arranging the device 10 by the display; extracting a data item of the plurality of data items 25, 26, 27, 28, 29, wherein said data item is to be transmitted from the device 10 to the database 14; inputting, to the client, an input 20 corresponding to a data item; transmitting said input 20 from the client 12 to the database 14; transmitting an output 22 corresponding to the input 20 from the database 14 to the client 12; displaying, on the client display 11, the output 22 such that the device 10 can read said output 22; reading the output 22 by means of a reader 16 of the device 10; comparing, in the device 10, the output 22 with said extracted data item of the plurality of data items 25, 26, 27, 28, 29; and if the output 22 corresponds to the extracted data item of the plurality of data items 25, 26, 27, 28, 29, acknowledging that said extracted data item has been transmitted from the device 10 to the database 14. The present invention comprises in a second aspect a system for transmission of data from a device 10 to a database 14, wherein the data is divided into a plurality of data items 25, 26, 27, 28, 29.

1. A method for transmitting, via a client having a display, data from a device to a database, wherein said data is divided into a plurality of data items, said method comprising:
arranging (501) the device by the client display;
extracting (505) a data item of the plurality of data items, wherein said data item is to be transmitted from the device to the database;
inputting (506), to the client, an input corresponding to a data item;
transmitting (507) said input from the client to the database;
transmitting (508) an output corresponding to the input from the database to the client;
displaying (509), on the display of the client, the output such that the device can read said output;
reading (510) the output by means of a reader of the device;
comparing (511), in the device, the output with said extracted data item of the plurality of data items; and
if the output corresponds to the extracted data item of the plurality of data items, acknowledging (512a) that said extracted data item has been transmitted from the device to the database.

2. The method according to claim 1, wherein the step of inputting, to the client, is achieved by means of an inputting means of the client.

3. The method according to claim 2, wherein the inputting means of the client is a touch screen, and wherein the device comprises outputting means for interacting with the touch screen.

4. The method according to claim 2, wherein the inputting means of the client comprises at least one in the group of: keyboard, mouse, trackball, touch screen, game controller, joystick.

5. The method according to claim 1, wherein the device is arranged on a predetermined read-out area on the display, and wherein said displaying an output is performed within the read-out area.

6. The method according to claim 1, wherein the display of the client is a touch screen, and wherein the client defines a read-out area by sensing the device arranged on the display, and wherein said displaying an output is performed within the read-out area.

7. The method according to claim 1, further comprising
transmitting (502), from the database to the client, a request output for the data item of the plurality of data items to be transmitted;
displaying (503), on the display of the client, the request output such that the device can read said request output; and
reading (504) said request output by means of the reader of the device.

8. The method according to claim 1, further comprising displaying, on a display of the device, a symbol corresponding to the data item to be transmitted.

9. The method according to claim 1, further comprising, if the output does not correspond to the extracted data item of the plurality of data items, transmitting (512b) an error code from the device to the client.

10. The method according to claim 1, wherein said extracting a data item, inputting an input, transmitting said input, transmitting an output, displaying the output, reading the output, and comparing the output with said extracted data item are repeated until each data item of the plurality of data items has been acknowledged to been transmitted from the device to the database.

11. A system for transmission of data (24) from a device (10) to a database (14), wherein the data is divided into a plurality of data items (25, 26, 27, 28, 29), said system comprising:
the device (10) comprising a reader (16);
a client (12) comprising a display (11); and
the database (14), wherein the database (14) is connected to the client (12);
wherein said device (10) is adapted to be arranged by the client display (11);
wherein said device (10) is adapted to extract a data item of the plurality of data items to be transmitted from the device (10) to the database (14);
wherein said client (12) is adapted to receive an input (20) corresponding to a data item;
wherein said client (12) is adapted to transmit said input (20) from the client (12) to the database (14);
wherein said database (14) is adapted to receive said input (20) from the client (12);
wherein said database (14) is adapted to transmit an output (22) corresponding to said input (20);
wherein said client (12) is adapted to receive, from the database (14), the output (22) corresponding to said input (20);
wherein said client (12) is adapted to display, on the client display (11), the output (22) corresponding to said input (20);
wherein said device (10) is adapted to read the output (22) by means of the reader (16);
wherein said device (10) is adapted to compare the output (22) with said extracted data item of the plurality of data items; and
wherein, if the output (22) corresponds to the extracted data item of the plurality of data items, the device (10) is adapted to acknowledge that said extracted data item has been transmitted from the device (10) to the database (14).
